(19) United States
(12) Patent Application Publication
(10) Pub. No.: US 2013/0046613 A1
(43) Pub. Date: Feb. 21, 2013

(54) OPTIMIZING TARGETING EFFECTIVENESS BASED ON SURVEY RESPONSES

(71) Applicants: Ayman Farahat, Santa Clara, CA (US); Ken Mallon, Foster City, CA (US)

(72) Inventors: Ayman Farahat, Santa Clara, CA (US); Ken Mallon, Foster City, CA (US)

(73) Assignee: YAHOO! INC., Sunnyvale, CA (US)

(21) Appl. No.: 13/213,530

(22) Filed: Aug. 19, 2011

(51) Int. Cl. G06Q 30/00

(52) U.S. Cl. 705/14.43; 705/14.66; 705/14.44

(57) ABSTRACT

An optimized targeting system can properly identify and determine information about an audience as part of the targeting process. Surveys may be used in place of advertisements on a page for receiving specific information about an audience that can be combined with known targeting data to generate an optimization model that better targets the audience. The model may be used for selecting targeted advertisements based on information about the audience. Interactions with the targeted advertisements and additional survey responses may be used to further refine the model. The model may consider and account for selection bias in the survey responses.

### BACKGROUND

Online advertising may be an important source of revenue for enterprises engaged in electronic commerce. Processes associated with technologies such as Hypertext Markup Language (HTML) and Hypertext Transfer Protocol (HTTP) enable a web page to be configured to display advertisements. Advertisements may commonly be found on many web sites. For example, advertisements may be displayed on search web sites and may be targeted to individuals based upon search terms provided by the individuals.

As the Internet has grown, the number of web sites available for hosting advertisements has increased, as well as the diversity among web sites. In other words, the number of web sites focusing on selective groups of individuals has increased. As a result of this increase, it has become increasingly difficult for advertisers to optimize the targeting of their advertisements. Advertisers may be unfamiliar with the most effective ways to target their advertisements on websites and in sponsored searching. This may result in a lower rate of return for the advertiser. That advertiser may have received a greater rate of return had the advertiser targeted his advertisement more effectively.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 illustrates an embodiment of an optimizer;

FIG. 3 illustrates an exemplary page;

FIG. 4 illustrates an exemplary survey;

FIG. 5 illustrates exemplary targeting optimization communications; and

FIG. 6 illustrates an exemplary flowchart for targeting optimization.

### DETAILED DESCRIPTION

By way of introduction, advertising may be more effective when it is properly targeted based on the audience viewing the advertisement. Identifying the audience and determining information about that audience are part of the targeting process. Surveys used in place of advertisements on a page may be one source of receiving specific information about an audience. Combining survey responses with known targeting data can be used to generate an optimization model that better targets the audience. The model may be used for selecting targeted advertisements. Interactions with the targeted advertisements and additional survey responses may be used to further refine the model. The model may consider and account for selection bias in the survey responses.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

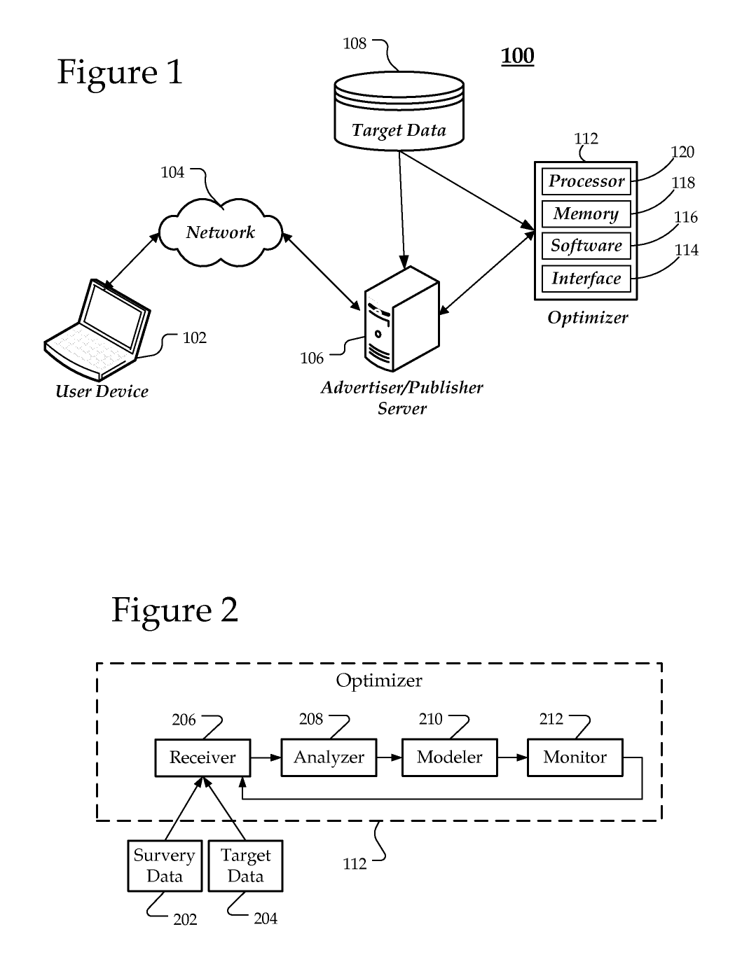

FIG. 1 depicts a block diagram illustrating one embodiment of an exemplary network system 100. The network system 100 may provide a platform for the modeling of an audience for providing targeted advertisements (“ads”) based on survey data and other target data. In the network system 100, a user device 102 is coupled with a advertisement/publisher (“ad”) server 106 through a network 104. An optimizer 112 may be coupled with the ad/publisher server 106. Target data 108 may be from external sources and may include tracking information that is provided to the ad/publisher server 106 and is used by the optimizer 112. The target data 108 may include survey data that is collected from the ad/publisher server 106. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be a computing device which allows a user to connect to a network 104, such as the Internet. Examples of a user device include, but are not limited to, a personal computer, personal digital assistant (“PDA”), tablet, tablet computer, smartphone, cellular phone, or other electronic device. The user device 102 may be configured to allow a user to interact with the web server 106, the ad/publisher server 106, or other components of the network system 100. The user device 102 may include a keyboard, keypad or a cursor control device, such as a mouse, or a joystick, touch screen display, remote control or any other device operative to allow a user to interact with content provided by the ad/publisher server 106 via the user device 102. In one embodiment, the user device 102 is configured to request and receive information from the ad/publisher server 106. The user device 102 may be configured to access other data/information in addition to web pages over the network 104 using a web browser, such as INTERNET EXPLORER® (sold by Microsoft Corp., Redmond, Wash.) or FIREFOX® (provided by Mozilla). The data displayed by the browser may include advertisements. In an alternative embodiment, software programs other than web browsers may also display advertisements received over the network 104 or from a different source.

The ad/publisher server 106 may act as an interface through the network 104 for providing a web page to the user device 102. In one embodiment, there may be a separate publisher server and advertisement server, where the publisher server is operated by the publisher server and the advertisement server provides advertisements from an advertiser. In another embodiment, the publisher server may be a web server that provides content from the publisher, and the ad server provides advertisements from an advertiser that is included with the content from the publisher. In another embodiment, there may be a separate web server that acts as the interface with the user device 102 that connects with the ad/publisher server 106. In other words, the as shown in FIG. 1, the ad/publisher server 106 may be three different servers, a web server, an advertisement server, and/or a publisher server. As described below, the ad/publisher server 106 will be described as providing content to the user device 102 even though there may be additional intermediary components (e.g. a web server) that provide the content on behalf of the publisher and/or advertiser for the ad/publisher server 106.

The pages that are provided to the user device 102 from the ad/publisher server 106 (or web server) may include advertisements. In one embodiment, the ad/publisher server 106 may include or be coupled with a search engine, and the provided page may be a search results page that includes advertisements. In one example, a web server may receive requests from the user device 102and route data from the search engine and/or the ad/publisher server 106 for display back on the user device 102.

In its role as an ad server, the ad/publisher server 106 may provide advertisements with or as a part of the pages provided to the user device 102. Alternatively, the ad/publisher server 106 may provide advertisements to a web server that adds them to web pages that are provided to the user device 102. The ad/publisher server 106 may provide advertisements for display in web pages, such as the publisher's pages. The advertisements may relate to products and/or services for a particular advertiser. The advertiser may pay the publisher for advertising space on the publisher's page or pages.

In its role as a publisher server, the ad/publisher server 106 may provide pages (e.g. web pages) to the user device 102. The ad/publisher server 106 may be a web server that provides the user device 102 with pages (including advertisements) that are requested by a user of the user device 102. In one example, the publisher may be a news organization, such as CNN ® that provides all the pages and sites associated with www.cnn.com. Accordingly, when the user device 102 requests a page from www.cnn.com, that page is provide over the network 104 by the ad/publisher server 106. As described below, that page may include advertising space or advertisement slots that are filled with advertisements viewed with the page on the user device 102. The ad/publisher server 106 may be operated by a publisher that maintains and oversees the operation of the publisher server 106.

The publisher may be any operator of a page displaying advertisements. The publisher may oversee the ad/publisher server 106 by receiving advertisements from an advertiser that are displayed in pages provided by the ad/publisher server 106. In one embodiment, an optimizer 112 may be used to develop a targeting model for optimizing the effectiveness of advertisements. The optimizer 112 may receive and analyze targeting data, including survey data, in generating a targeting model.

In one embodiment, there may be web database in the network system 100 that stores information about the pages and/or content that are provided to the user device 102. For example, an exemplary database may include records or logs of at least a subset of the requests for data/pages submitted over the network 104. In one example, the database may include a history of Internet browsing data related to the pages provided. The stored data may relate to or include various user information, such as preferences, interests, profile information or browsing tendencies, and may include the number of impressions and/or number of clicks on particular advertisements. The data may also include target data and/or survey data as discussed below.

The target data 108 may be stored in a database coupled with the ad/publisher server 106 and may store the pages or data that is provided by the ad/publisher server 106. The database may include records or logs of at least a subset of the requests for data/pages submitted to the publisher server/ad 106 over a period of time. In one example, the database may include a history of Internet browsing data related to the pages provided by the ad/publisher server 106. The data stored in the database may relate to or include various user information, such as preferences, interests, profile information or browsing tendencies, and may include the number of impressions and/or number of clicks on particular advertisements. As discussed below, survey information may be collected, analyzed, and stored in the target data 108 database. The database may store advertisements from a number of advertisers, such as images, video, audio, text, banners, flash, animation, or other formats may be stored in the database. A generated targeting model may be used to identify which advertisements should be displayed to which users. In an alternative embodiment, there may be another advertising database that stores advertisements and/or advertisement records. Advertisement records including the resulting impressions, clicks, and/or actions taken for those advertisements may also be stored. The stored data may include targeting data and survey data that the optimizer 112 uses for generating and refining a targeting model that is used for targeting advertisements to an audience. The data may be continuously updated to reflect current viewing, clicking, and interaction with the advertisements displayed on the user device 102, including updates for additional survey responses that are received.

The optimizer 112 may generate a targeting model based on data from the target database 108. The targeting model predicts how a user or an audience will respond to advertising. The optimizer 112 may be coupled with the ad/publisher server 106 for analyzing survey data and assessing the effectiveness of the ads, which reflects the effectiveness of the targeting of those ads. In one embodiment, the optimizer 112 may be controlled by a publisher and/or an advertiser and may be a part of the ad/publisher server 106. Alternatively, the optimizer 112 may be a separate entity that analyzes the target data 108 as well as other tracking data from the ad/publisher server 106.

The optimizer 112 may be used by the ad/publisher server 106 for identifying advertisements to display based on the user/audience viewing a page. As discussed, the model may receive targeted survey responses that are combined with other target data to develop a prediction model for determining which advertisements should be targeted to which users. The optimizer 112 may be a computing device for analyzing and modeling targeting data. The optimizer 112 may include a processor 120, a memory 118, software 116 and an interface 114. The optimizer 112 may be a separate component from the ad/publisher server 106, or it may be combined as a single component or hardware device.

The interface 114 may communicate with the user device 102 and/or the ad/publisher server 106. The interface 114 may include a user interface configured to allow a user and/or administrator to interact with any of the components of the optimizer 112. For example, the administrator and/or user may be able to review or update the targeting model used by the optimizer 112, including updating or changing the survey provided to users.

The processor 120 in the optimizer 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The interface 114 may be a user input device or a display. The interface 114 may include a keyboard, keypad or a cursor control device, such as a mouse, or a joystick, touch screen display, remote control or any other device operative to allow a user or administrator to interact with the optimizer 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters. In particular, the interface 114 may allow a user to interact with the optimizer 112 to view or modify the target data, survey data, and/or the targeting model.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a network, including but not limited to the network 104. For example, the optimizer 112 may be coupled with the ad/publisher server 106 through a network. Accordingly, any of the components in the system 100 may include communication ports configured to connect with a network.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. As discussed, the ad/publisher server 106 may provide advertisements and/or content to the user device 102 over a network, such as the network 104.

The optimizer 112, the ad/publisher server 106, and/or the user device 102 may represent computing devices of various kinds. Such computing devices may generally include any device that is configured to perform computation and that is capable of sending and receiving data communications by way of one or more wired and/or wireless communication interfaces, such as interface 114. For example, the user device 102 may be configured to execute a browser application that employs HTTP to request information, such as a web page, from the web server 106.

FIG. 2 illustrates an embodiment of an optimizer 112. The optimizer 112 may include a receiver 206, an analyzer 208, a modeler 210, and a monitor 212. The receiver 206 receives the inputs for the optimizer 112. In one embodiment, the receiver 206 includes survey data 202 and target data 204 as inputs. The survey data 202 is discussed below with respect to FIG. 4 and includes a user response to a survey displayed in place of an advertisement on a page. The displayed page may include a specific survey in an advertisement slot in order to receive the survey data 202, which can be used for determining which ad should be displayed in that advertisement slot depending on the user viewing the page. The target data 204 includes other known information about the page and/or the user that can be used to target an advertisement. The target data 204 may relate to or include various user information, such as preferences, interests, profile information or browsing tendencies, and may include the number of impressions and/or number of clicks on particular advertisements. The target data 204 may also include a history of Internet browsing data related to the pages provided. The known information about the user of a particular page may be relevant for targeting.

The analyzer 208 receives the input data (survey and/or target) for analysis. In one embodiment, the survey data 202 and the target data 204 are combined for the generation of a model. In alternative embodiments, the analyzer 208 may analyze the survey data 202 to determine the reliability and accuracy of the survey responses. For example, the analyzer 208 may determine the existence of selection bias and filter the survey data 202 to remove selection bias, which improves the accuracy of the data.

The fact that some users take a survey and some users do not take the survey may result in responses that are not a completely accurate depiction of the received answers. For example, users with no interest in the survey topic (e.g. pizza delivery) may ignore the survey, which means that the received survey responses suggest a higher interest in the topic among the users than actually exists. Rather than selection bias, this may also be referred to as no-response bias.

Each survey response may represent a case of self-selection with users self-selecting to participate in the survey. Self-selection bias may arise when individuals select themselves into a group, causing a biased sample. The external validity of the survey (applicability to general population which is what the survey is intended to measure) may be at risk if the characteristics of the people that cause them to select themselves in the group (i.e., respond to survey), also impacts their response to the survey. While some of these characteristics may be observed and adjusted for using propensity score and stratification, there may exist other non-observable characteristics that vary between individuals that can impact survey response. Statistical analyses based on those non-randomly selected samples may lead to erroneous conclusions. The Heckman correction is a two-step statistical approach that offers a means of correcting for non-randomly selected samples (selection bias). The Heckman selection models may be defined as:

Selection: yⱼ¹=f(xⱼ¹)+eⱼ¹

output: yⱼ²=f(xⱼ²)+eⱼ²

where the selection equation describes whether a user “j” with features xⱼ¹ takes the survey and eⱼ¹ is the selection model disturbance. If the user selects to respond to survey, then yⱼ¹=1, and the observed outcome is yⱼ². The output may depend on feature set xⱼ² and a model disturbance eⱼ².

The bias may arise when xⱼ² are correlated with eⱼ² and the two models disturbances are correlated:

$$E ( cov ( {e}_{j}^{1} , {e}_{j}^{2} ) ) = [ \begin{matrix}{σ}_{1}^{2} & ρ \\ ρ & {σ}_{2}^{2}\end{matrix} ] , ρ \neq 0$$

(E denotes the taking the expectation). The model may take into account the impact of selection bias on the outcome equation.

Selection bias may be tested for by determining whether the correlation between the two disturbances ρ is different from zero. If the correlation coefficient is zero, then we can model the output using the factors that only impact the outcome. However, if the correlation coefficient is not zero then the output of user “j” may depend not only on the factors that impact the outcome, but also on the factors that impact a user's decision to respond to survey.

The Heckman analysis may be used to check for selection bias. In particular, the correlation between the model disturbance of selection and outcome equation is determined. If that value (p) is small, then it suggests there is no selection bias. The analysis may be performed for different sites/pages/properties to determine whether certain sites have a higher survey response rate and/or a difference in selection bias. Differences between sites may be impacted based on an amount of time spent on a site. For example, an interactive site may require a user to spend more time than a weather site where a user just checks the weather and leaves the site. The longer a user lingers on a page, the more likely they are to responds to the survey.

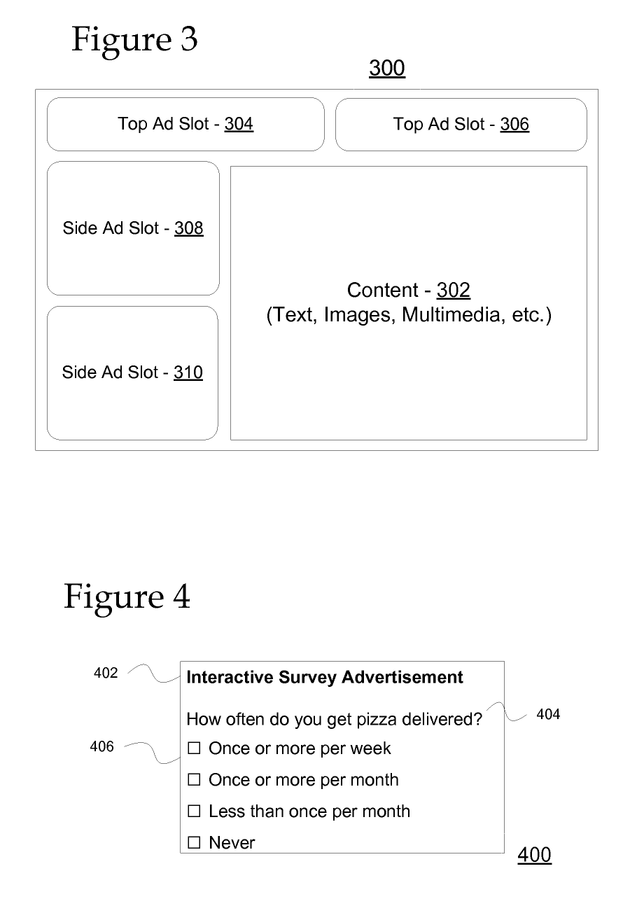

Referring to FIG. 2, the modeler 210 generates a targeting model based on the data received. In alternative embodiments, the analyzer 208 may be optional and the receiver 206 may provide the data directly to the modeler 210. The modeler 210 may include the functions described above with the analyzer 208 including the analysis of selection bias. The modeler 210 may also be referred to as a generator. The targeting model that is generated utilizes the survey responses that are received for determining which users have a higher propensity to buy a particular product or service. In one embodiment, the survey is displayed to a user in one of the advertisement slots of a page, such as the exemplary page 300 shown in FIG. 3.

In FIG. 3, exemplary page 300 may be a web page available via the Internet, or may be a page or screen from any software program. The content 302 may be displayed in the center of the page 300. Page 300 may include multiple advertisements displayed around the main content 302. In one embodiment, there may be two top advertising slots 304, 306 for displaying advertisements at the top of the screen. Additionally, there may be two side advertising slots 308, 310 displaying advertisement at the side of the screen. Advertisement slots may also be referred to as an advertising location or just an advertisement. FIG. 3 is merely exemplary of a screen or page displaying advertisements. The content 302 that may be displayed may be an image, video, audio, other multimedia, text or any other visual display that may be included in a page. For example, the content 302 may include an image that links to other pages within the site. Although that content may not be categorized as an advertisement, it may still be targeted to a user based on the model. For simplicity, targeting advertisements will be described throughout this disclosure, rather than targeting of other content.

FIG. 4 illustrates an exemplary survey 400 that may be displayed in place of any of the advertising slots 304, 306, 308, 310 from FIG. 3. In alternative embodiments, the survey 400 may be a pop-up window, floater window/tab, new tab, or new window that is displayed to the user. For example, the survey 400 may be displayed as a pop-up over any of the ad slots 304, 306, 308, 310 or over the content 302. The survey 400 includes an optional title 402 that notifies the user that it is a survey. The question 404 is displayed as part of the survey along with potential answers 406 for the survey. The example shown in FIG. 4 is a question 404 with check boxes for the answers 406. There may be more or fewer choices for the answers 406 in alternative embodiments. Alternatively, the answer 406 may be a blank text box that allows the user to input a response. The survey 400 may be designed to extract information from a user in the form of answers 406 that can be combined with what is already known about the user based on other profile or targeting information.

The survey responses may provide more specific targeting than standard profile information. In one embodiment, the advertiser may notify the publisher that they want their ad displayed to women 18-34 who prepare at least 10 meals per week at home. Based on this criteria the publisher must identify users to properly target to that demographic. Surveys may be used to improve on the targeting.

For the example shown in FIG. 4, the survey question 404 is about whether the user orders pizza delivery. Demographics (e.g. males aged 18-40) may be assumed to satisfy that question, but the survey can confirm known information or provide information that was not previously known (e.g. families with kids order more pizza). Assuming the advertiser is a pizza delivery chain whose goal is to create awareness in people who most frequently order pizza delivery. Ideally, their ad would be displayed most frequently to the users/audience who most frequently orders pizza delivery. As described, the survey 400 may be used as an in-ad poll that obtains survey responses that are anonymously included with already known targeting information (e.g. inferred interests and user attributes). The model may be used to rank potential users based on their estimated propensity to order pizza delivery.

The collected survey responses form a set of responses for a target group that an advertiser would like to reach. In particular, the responses are used to find and identify the users who responded in the desired way, and then those users' data (profile) is retrieved. The user data (profile) may include demographics, web usage . . . etc. Based on that profile, the model can identify similar users (i.e. users with a similar profile). The ranking of potential users may be based on a similarity with profiles of other users who responded in the desired way to a survey. Selection bias may be used to identify a potential systematic reason why some users respond to a survey in a certain way. For example, if older users do or do not respond to the survey, then this bias may need to be accounted for. If the users responding to the survey or the users that are missing from responding to the survey are random, then that may be an absence of selection bias.

Referring back to FIG. 2, the monitor 212 continues to track the effectiveness/success of the targeted advertisement. In alternative embodiments, the monitor 212 may be referred to as a tracker that tracks performance for optimizing the model. The functions provided by the monitor 212 may be a part of the modeler 210 in alternative embodiments. The clicks or actions on the targeted advertisement may be one measure of the effectiveness of the targeting. In addition, the monitor 212 may continue to periodically display and receive survey responses to further refine and update the model. For example, the survey may still be displayed to a user with a high propensity to be interested in the advertised product in order to confirm the model's conclusion. In one embodiment, every Nth display of the advertisement may include the survey, where N is an integer (e.g. every 3^{rd} display, every 10^{th} display, etc.). The monitor 212 may ensure that the advertisement campaign continues to target effectively by monitoring targeted ad success and with the continued receipt of the survey responses. As the model is refined by further target data and survey data, it may become more accurate and the targeting is more effective.

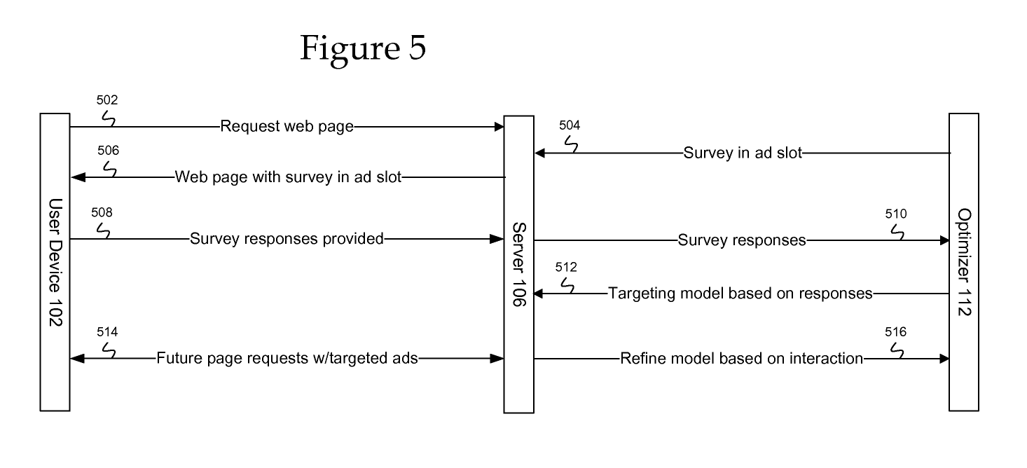

FIG. 5 illustrates exemplary targeting optimization communications. In particular, FIG. 5 illustrates one embodiment of the generation and application of a targeting model using survey responses from users. In block 502, a user/audience may request a web page from the server. The server receives the web page request and retrieves and/or generates the requested page, including adding advertisements. In place of or in addition to the advertisements, a survey is provided with the web page in block 504. The server returns the requested web page that includes the survey in block 506. Although many users may ignore the survey, some users will complete the survey and the survey responses are provided in block 508. The survey responses are provided to the optimizer 112 in block 510 for generating a targeting model based on the responses as in block 512. Once the targeting model is generated, future requests for web pages may include advertisements that are targeted based on the generated targeting model as in block 514. Continued monitoring of the accuracy of the model (including further surveys and responses) may be used to further refine the model as in block 516.

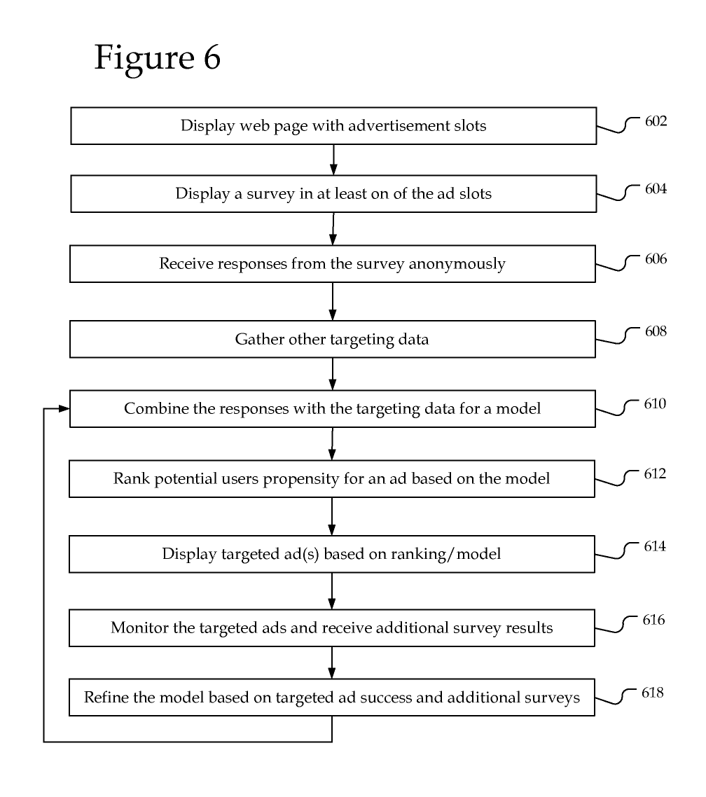

FIG. 6 illustrates an exemplary flowchart for targeting optimization. In block 602, a page (e.g. web page) is displayed to a user that includes advertisement slots with a survey displayed in at least one of the advertisement slots as in block 604. In alternative embodiments, the survey may be presented in different locations/formats, rather than in an advertisement slot as described. Responses to the survey are received in block 606 and other targeting data is gathered for analysis in block 608. The other targeting data may include the target data 204 described with respect to FIG. 2. The survey responses and other target data may be combined and analyzed for the generation of a targeting model in block 610. In block 612, the model may be used to rank potential users' potential interest in a product or service which an advertiser is interested in advertising. The ranking may include a percentage estimate from the model that a particular user is predicted to be interested in the targeted advertisement. Based on the ranking, the ads that are most relevant will be shown to those users with the highest predicted interest in what is being advertised as in block 614. The targeted advertisements that are displayed are tracked and additional survey results may be used in block 616 for refining the targeting model and/or updating the ranking of users as in block 618.

The system and process described may be encoded in a signal bearing medium, a computer readable medium such as a memory, programmed within a device such as one or more integrated circuits, and one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method for advertisement targeting comprising:
displaying an in-advertisement survey in at least one advertisement slot on a page;
receiving responses to the in-advertisement survey;
combining the responses from the in-advertisement survey anonymously with existing targeting data;
generating a model based on the combination of the responses and the existing targeting data, wherein the model comprises an identification of desirable users from the responses and an identification of desirable potential users based on a comparison of the existing targeting data associated with the desirable users with the existing targeting data associated with potential users; and
targeting the desirable potential users based on the model by displaying a targeted advertisement in the at least one advertisement slot on the page.

2. The method according to claim 1 wherein the existing targeting data for the desirable users and the potential users comprises profile information for the users.

3. The method according to claim 1 wherein the in-advertisement survey relates to interest in a particular topic and the particular topic is a product or service for purchase, further wherein the targeting identifies users with a propensity to purchase the product or service.

4. The method according to claim 1 further comprising:
replacing the in-advertisement survey on the page with a targeted advertisement based on the model and ranking.

5. The method according to claim 4 wherein the in-advertisement survey is displayed periodically rather than the targeted advertisement.

6. The method according to claim 5 further comprising:
monitoring an effectiveness of the targeted advertisement based on an interaction with the targeted advertisement and based on additional results from the randomly displayed in-advertisement survey.

7. The method according to claim 1 further comprising:
analyzing the responses to the in-advertisement survey to identify any selection bias; and
updating the model to account for the selection bias.

8. The method according to claim 1 wherein the in-advertisement survey comprises a pop-up window upon an interaction from the user.

9. In a computer readable medium having stored therein data representing instructions executable by a programmed processor for targeting advertisements, the storage medium comprising instructions operative for:
providing a survey;
receiving results from the survey;
identifying a targeted advertisement by generating a model based on the results from the survey, wherein the model uses the results from the survey to identify desirable profile information that is used to identify users to target that match the desirable profile information; and
updating the model by periodically providing the survey and recording additional responses to the survey to refine the model.

10. The computer readable medium of claim 9 further comprising:
providing a web page with advertisement slots;
displaying the survey in one of the advertisement slots;
replacing the survey with the targeted advertisement; and
updating the model by periodically including the survey in place of the targeted advertisement to receive the additional responses.

11. The computer readable medium of claim 9 further comprising:
monitoring an effectiveness of the identified targeted advertisement based on an interaction with the targeted advertisement.

12. The computer readable medium of claim 11 wherein the updating of the model is further refined based on the monitored effectiveness of the identified targeted advertisement.

13. The computer readable medium of claim 9 wherein the model generates a ranking of users and available advertisements, further wherein the ranking is used for the identifying of the targeted advertisement.

14. The computer readable medium of claim 13 wherein the survey relates to interest in a product or service for purchase, and the ranking is based on a propensity to purchase the product or service.

15. A computer system for generating a targeting model comprising :
a network;
an advertiser server coupled with the network and configured to provide a page including at least one advertisement and at least one survey; and
an optimizer coupled with the advertiser server and configured to optimize advertisement targeting, wherein the optimizer further comprises:
a receiver that receives responses to the at least one survey and other target data;
a modeler that generates the targeting model based on responses to the at least one survey and based on the other target data; and
a monitor that refines the targeting model based on additional survey responses and based on effectiveness of the advertisement targeting;
wherein the at least one advertisement included on the page from the advertiser server is selected based on the targeting model.

16. The system of claim 15 further comprising:
a target database that includes the other target data.

17. The system of claim 16 wherein the other target data comprises at least one of preferences, interests, profile information, demographics, or browsing tendencies.

18. The system of claim 15 wherein the at least one survey is displayed in place of one of the advertisements.

19. The system of claim 15 wherein the at least one survey is displayed as a floater window on the page.

20. The system of claim 15 wherein the optimizer further comprises:
an analyzer that combines and analyzes the responses to the at least one survey and the other target data that are used by the modeler.
